(19) United States
(12) Patent Application Publication
(10) Pub. No.: US 2011/0005398 A1
(43) Pub. Date: Jan. 13, 2011

(54) Method and System to Produce Gourmet Coffee

(75) Inventors: Jorge B. Garcia, Rogers, AR (US); Charles Brian Gross, Greeley, CO (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: Wal-Mart Stores, Inc., Bentonville, AR (US)

(21) Appl. No.: 12/500,418

(22) Filed: Jul. 9, 2009

(51) Int. Cl. A47J 31/44; A47J 31/60

(52) U.S. Cl. 99/280; 99/285; 99/290; 99/299

(57) ABSTRACT

Various embodiments are directed to a beverage maker. The beverage maker may include a brew system, an indicator to indicate at least one of a cleaning and a maintenance need of the beverage maker, and a control circuit. The brew system may include a reservoir to receive a liquid, a heater to heat the liquid, an expendable filter structured to filter impurities from the liquid for at least a predetermined number of brew cycles, and a container for receiving a beverage brewed from the filtered liquid. The control circuit may include a processor configured to receive a signal from at least one sensor indicative of an end of a brew cycle, increment a brew cycle counter by one count at the end of each brew cycle, and activate the indicator when a value of the brew cycle counter is equal to the predetermined number of brew cycles.

### BACKGROUND OF THE INVENTION

Coffee beans must be ground and brewed in order to create a beverage. Grinding the roasted coffee beans is done at a roastery, in a grocery store, or in the home. They are most commonly ground at a roastery and then packaged and sold to the consumer, though “whole bean” coffee can be ground at home. Coffee beans may be ground in several ways. A burr mill uses revolving elements to shear the bean; an electric grinder smashes the beans with blunt blades moving at high speed; and a mortar and pestle crushes the beans.

The type of grind is often named after the brewing method for which it is generally used. Turkish grind is the finest grind, while coffee percolator or French press are the coarsest grinds. The most common grinds are between the extremes; a medium grind is used in most common home coffee brewing machines.

Machines such as percolators or automatic coffeemakers brew coffee by gravity. In a percolator, boiling water is forced into a chamber above a filter by steam pressure created by boiling. The water then passes downward through the grounds due to gravity, repeating the process until shut off by an internal timer or, more commonly, a thermostat that turns off the heater when the entire pot reaches a certain temperature. This thermostat also serves to keep the coffee warm (it turns on when the pot cools), but requires the removal of the basket holding the grounds after the initial brewing to avoid additional brewing as the pot reheats.

In an automatic coffeemaker, hot water drips onto coffee grounds held in a coffee filter made of paper or perforated metal, allowing the water to seep through the ground coffee while absorbing its oils and essences. Gravity causes the liquid to pass into a carafe or pot while the used coffee grounds are retained in the filter.

Many people have daily routines in which they go to a coffeehouse to purchase gourmet cups of coffee. If a coffee drinker purchases two gourmet cups of coffee a day, at five dollars a cup, the gourmet coffee will end up costing the coffee drinker fifty dollars per week. As an alternative to buying the pricey coffeehouse coffee, the coffee drinker can purchase an expensive industrial coffee brewer that brews coffee in large predefined batches which are too large for an individual or family to timely enjoy. Additionally, the industrial brewers need special water filters and water pipe connections and are also difficult to maintain and clean. Therefore, what is needed is a system and method to use a gourmet drip coffeemaker which filters the brewing water and has special functionality to ensure a gourmet cup of coffee at home, the office or anywhere.

### SUMMARY OF THE INVENTION

In a first embodiment, a beverage maker with an oversized filter basket which is part of an overall gourmet brew system is disclosed. The brew system has a reservoir to receive a liquid, a heater to heat the liquid and an expendable filter structured to filter impurities from the liquid for at least a predetermined number of brew cycles. The present invention also includes a container for receiving a beverage brewed from the filtered liquid, an indicator to indicate at least one of a cleaning and a maintenance need of the beverage maker and a control circuit comprising a processor. The control circuit is configured to acquire an input from a gourmet brew switch in communication with the control circuit indicative of a gourmet brew mode and to receive a signal from at least one sensor indicative of an end of a brew cycle and indicate to a first indicator the end of brew cycle.

A second embodiment includes a method of operating a beverage maker with at least one brewing mode. The method acquires an input from a gourmet brew switch, wherein said signal is indicative of the beverage maker's gourmet mode. A processor receives a signal from at least one sensor, wherein the signal is indicative of an end of a brew cycle of the beverage maker and waiting a predetermined gourmet time to ensure that the liquid in the oversized filter basket is emptied and indicating an end of brew alert.

A third embodiment includes a control circuit for controlling a beverage maker with a processor in communication with a computer-readable medium. The computer-readable medium has instructions stored thereon, which, when executed by the processor, cause the processor to acquire an input from a gourmet brew switch in communication with the control circuit indicative of a gourmet brew mode and receive a signal from at least one sensor indicative of an end of a brew cycle and indicate to a first indicator the end of brew cycle.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The above-mentioned and other features and advantages of this disclosure, and the manner of attaining them, will become more apparent and the disclosure itself will be better understood by reference to the following description of various embodiments of the disclosure taken in conjunction with the accompanying figures, wherein:

FIG. 1 is a perspective view of a beverage maker of a preferred embodiment of the invention with its filter cover in an open position illustrating various parts, including a carafe, a filter basket and shower head.

FIG. 2 is perspective view of the dual water level indicator.

FIG. 3 is a partial perspective view of the beverage maker of FIG. 1, with the reservoir cover in the open position exposing the reservoir well and the top of the filter wand.

FIG. 4 is a an additional partial perspective view of the beverage maker of FIG. 1, showing a carafe pouring liquid into the reservoir well of the beverage maker.

FIG. 5 is a perspective view of a filter dipstick of a preferred embodiment of the invention with a filter cartridge installed the filter cage.

FIG. 6 is a perspective view of the filter dipstick of FIG. 5 with its filter cage open and without a filter cartridge.

FIG. 7 is an overall perspective view of an oversized coffee filter and the filter basket of a preferred embodiment of the invention.

FIG. 8 is a perspective view of the oversized coffee filter of FIG. 7.

FIG. 9 is a side view of the oversized coffee filter of FIG. 7.

FIG. 10 is an additional side view of the oversized coffee filter of FIG. 7.

FIG. 11 is a bottom view of the coffee filter of FIG. 7.

FIG. 12 is a top view of the coffee filter of FIG. 7.

FIG. 13 is a plan view of a drenching shower head of a preferred embodiment of the invention.

FIG. 14a is a perspective view of a coffee scoop of a preferred embodiment of the invention.

FIG. 14b is a top view of the coffee scoop of FIG. 14a.

FIG. 14c is a side view of the coffee scoop of FIG. 14a.

FIG. 15 is a block diagram of a beverage maker in accordance with a preferred embodiment of the invention.

FIG. 16 is an exemplary panel of the beverage maker of FIG. 1 comprising a display and user switches.

FIG. 17 is a flow chart of the brewing cycles of the beverage maker of FIG. 1.

FIG. 18 is a flow chart of the maintenance program of the beverage maker of FIG. 1.

FIG. 19 is a flow chart of the beverage maker's cleaning maintenance procedure.

FIG. 20 is a process flow illustrating a method of performing the cleaning process.

### DETAILED DESCRIPTION OF THE INVENTION

In the following detailed description, reference is made to the accompanying drawings, which form a part hereof and show by way of illustration specific embodiments in which the invention may be practiced. These embodiments are described in sufficient detail to enable those skilled in the art to practice them, and it is to be understood that other embodiments may be utilized, and that structural, logical, processing, and electrical changes may be made. The progression of processing steps described is an example; however, the sequence of steps is not limited to that set forth herein and may be changed as is known in the art, with the exception of steps necessarily occurring in a certain order.

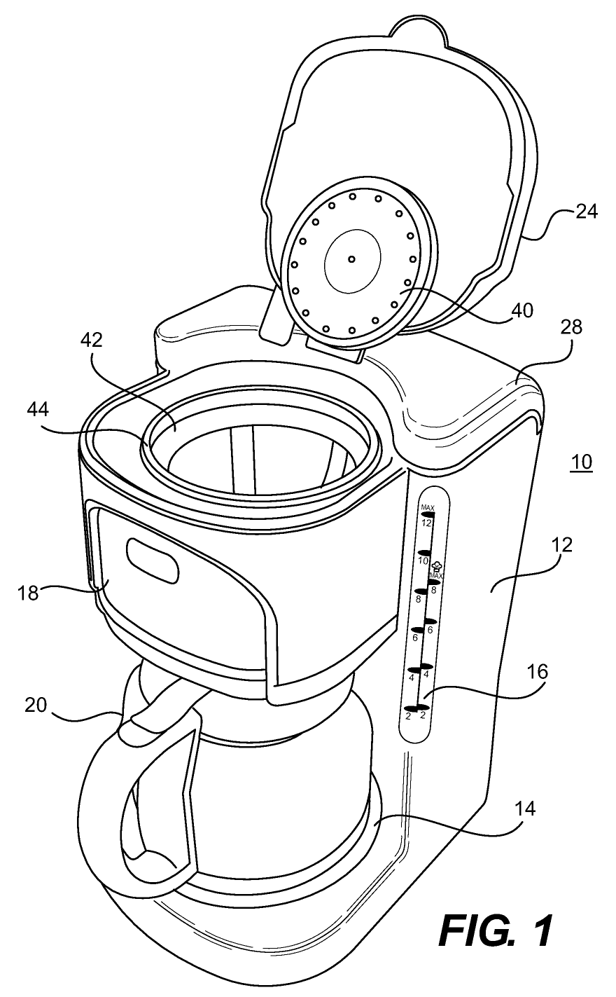

The invention will now be described with reference to the drawing figures in which like reference numerals refer to like parts throughout. Referring to FIG. 1, a beverage maker 10 can have an outer shell 12 and a heating plate 14 to keep the brewed beverage hot. A carafe 20 may be utilized to hold the brewed beverage. A dual level liquid indicator 16 indicates the amount of liquid in the beverage maker's reservoir well. It also indicates to the user the appropriate fill height for the amount of beverage to be brewed. A control and display panel 18 allows the user to program and monitor the beverage maker 10 brewing processes. A filter cover 24 (shown in the open position) allows access to an oversized filter basket 42 and the filter basket holder 44.

The heating plate 14 can be configured to heat, warm, and/or maintain the temperature of a brewed liquid, such as coffee, for example, within the liquid carafe 20, when the liquid carafe 20 is positioned on the heating plate 14. The liquid level indicator 16 can be used to visually indicate to a user of the beverage maker 10 the level of the liquid within the reservoir of the beverage maker 10, such that the user can determine the quantity of a beverage to be made by the beverage maker 10. The liquid level indicator 16 can be a transparent and/or semi-transparent portion, such that the user can view the level of the liquid within the container 22.

The beverage maker 10 can also have a drenching shower head 40, which is configured to drip, spray, channel, and/or flow the brewed beverage into the liquid carafe 20. The drenching shower head 40 may be linked to the filter cover 24 to pivot away from the oversized filter basket 42 and the filter basket holder 44 when the filter cover 24 is opened. The beverage maker 10 can be a coffee maker, a tea maker, a cappuccino maker, and/or any other suitable apparatus configured to brew or make a beverage. The control and display panel 18 may have an on/off switch, a timer, a clock, and/or various brewing cycle switches, for example. Those of skill in the art will recognize that the control and display panel 18 can comprise any other suitable switches, buttons, and/or indicators.

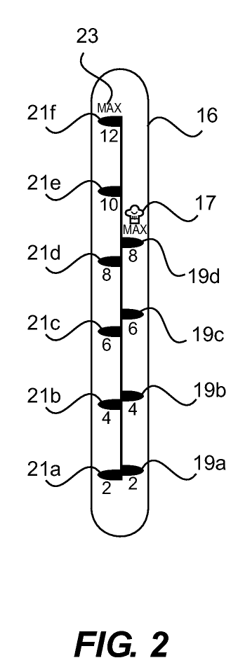

Referring to FIG. 2, the dual level liquid indicator 16 indicates the amount of liquid in the brewer's reservoir. Two level liquid indicators are provided because in gourmet mode, the brewer uses more grounded coffee and the additional grounded coffee absorbs more liquid. The right side illustrates the appropriate fill level for the gourmet brew and is incremented in two cup hash marks. For example, the gourmet “2” cup fill hash 19a is at the bottom of the dual level liquid indicator 16. The gourmet “4” cup fill hash 19b is the next hash mark is next followed by the gourmet “6” cup fill has 19c. At the top is the gourmet “8” cup fill hash 19d. A chef's hat 17 is also on the right side to remind the user that the right side is for the gourmet brew reservoir level and the current gourmet mode is provided for eight cups of coffee. The left side of the dual level liquid indicator 16 indicates the brewer's reservoir level for use when brewing in the regular mode. There are regular mode hash marks at 2, 4, 6, 8, 10 and 12 cup levels and is indicated by 21a-21f, respectively. At the top there is a max indicator 23 to remind the user the brewer is provide for twelve cups of coffee in regular coffee mode.

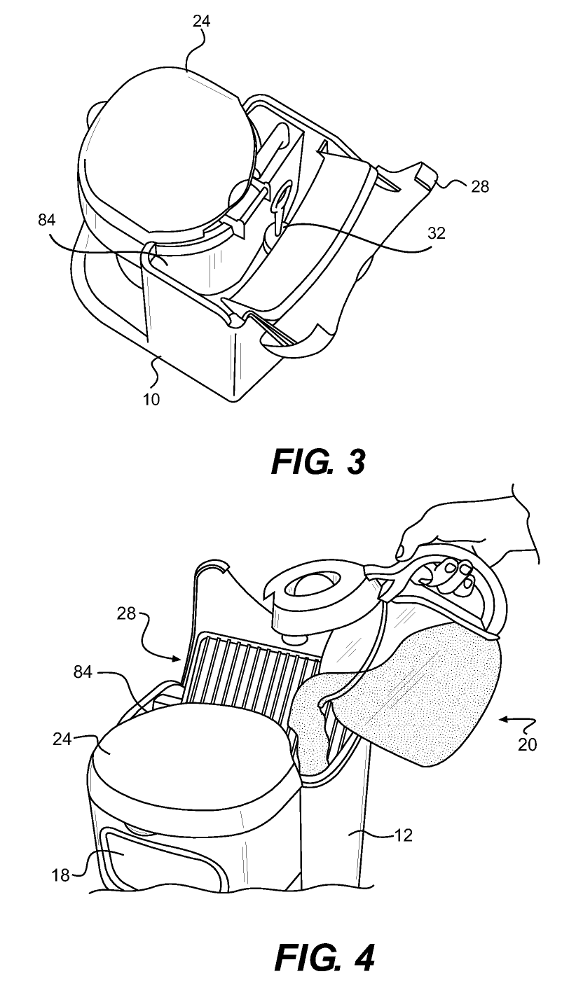

Referring to FIG. 3, the a reservoir lid 28 of the beverage maker 10 is shown in the open position allowing the user access to a water filter dipstick 32. The water filter dipstick 32 is placed inside the reservoir 84 to filter impurities from the liquid to be brewed. FIG. 4 illustrates the carafe 20 filling the reservoir 84 with liquid to be brewed.

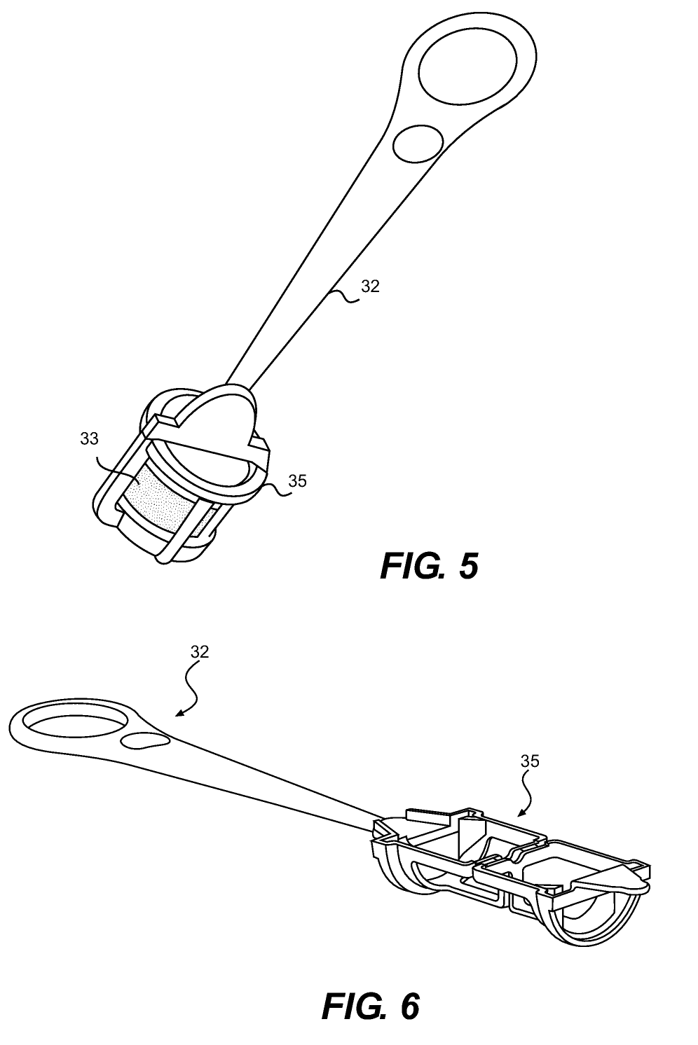

Referring to FIGS. 5 and 6, the water filter dipstick 32 is shown in detail. The water filter dipstick 32 is configured to hold a filter element 33, such as a charcoal filter, for example, on an end thereof. The filter dipstick 32 may use a filter cage 35 configured to receive the filter element 33, as shown in the open position in FIG. 6. As discussed above, the filter dipstick 32 is positioned near or at the bottom of the reservoir 84 at a receiving aperture permitting the beverage maker 10 to withdraw the liquid from the reservoir 84 via the receiving aperture.

A user can open the filter cage 35 to replace the filter element 33 after the filter element's useful life has expired. The useful life of the filter element 33 can be correlated to the cleaning cycle of the beverage maker. In some embodiments, the beverage maker circuitry may be configured to keep track of brews between filter changes and alert the user for its need to be replaced. Additionally, the filter material (e.g., charcoal) contained within the filter element 33 may be selected to provide effective filtration for a number of brew cycles dictated by the cleaning/maintenance requirements of the beverage maker 10. For example, if the beverage maker 10 requires cleaning/maintenance every 60 brew cycles, the amount of filter material may be selected to provide effective filtration for at least 60 brew cycles. In this way, the filter may be replaced concurrently with cleaning/maintenance activities.

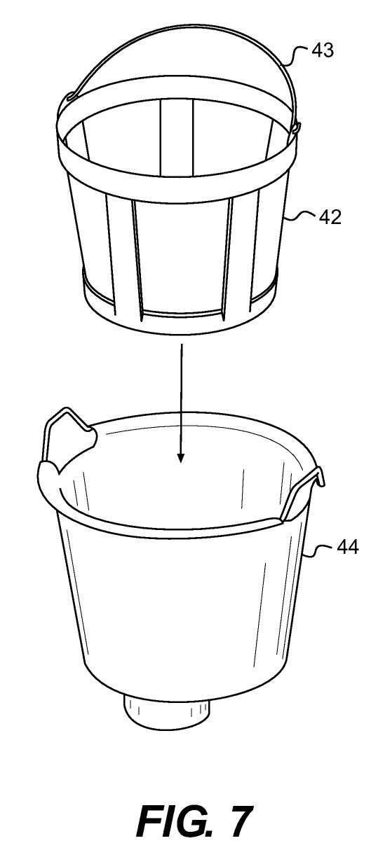

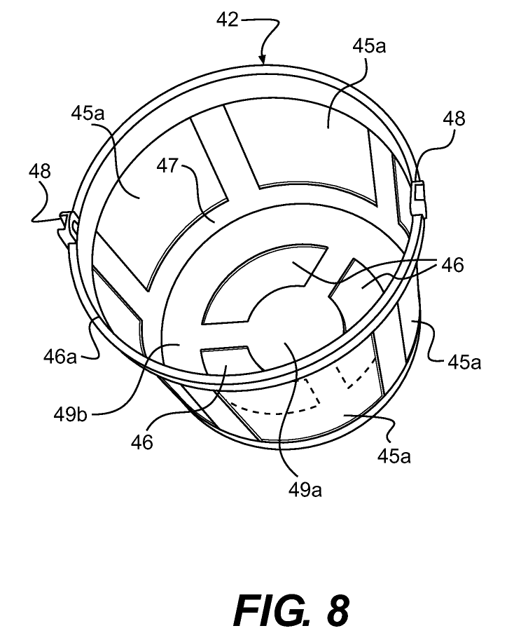

Referring to FIG. 7, an oversized filter basket 42 is provided which is inserted into a filter basket holder 44, which is placed into the beverage maker 10 (see FIG. 1). A handle 43 attaches at handle attachment openings 48 of the oversized filter basket 42. Referring to FIG. 8, the oversized filter basket 42 may be configured with five side filter outlets 45a, three bottom filter outlets 46, a lower wall 47, an inner disc 49a and an outer disc 49b.

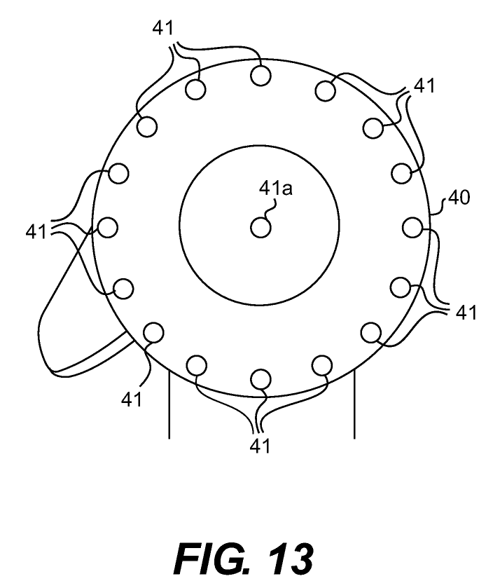

The filter basket's design ensures a consistent quality of brew, regardless of the quantity of beverage to be brewed. Thus, the coffee produced in beverage maker will taste the same whether if it brews two or twelve cups of coffee. The consistent brew quality is achieved with the shape of the oversized filter basket 42. For example, when a user is brewing a low quantity of a beverage, the lower wall 47 keeps water from flowing through side filter outlets by redirecting the water to flow through the grounds and exit through the bottom filter outlets 46. Additionally, due to surface tension and other properties of liquids, water in a coffee filter tends to exit at the bottom center of the coffee filter. The inner disc 49a of the present invention prevents this by directing the brew away from the center and exit through the bottom filter outlets 46 of the filter basket. The drenching shower head shown in FIG. 13, also aids in the brewing process by distributing the hot water over the entire grounds of the oversized filter basket 42.

When a user is brewing larger quantities of a beverage, the oversized filter basket 42 will also have a large quantity of grounds in it. The drenching shower head ensures that the grounds will get saturated and thus the maximum flavor will be extracted. This is especially important when the beverage maker 10 is in a gourmet mode. Additionally, other filter configurations may also be utilized, as long as the configuration permits swift and efficient extraction of the liquid from the grounds from the filter basket. For example, there may be three side filter outlets and three bottom filter outlets. The filter openings of the oversized filter basket 42 may have a microscreen mesh filtering material allowing the brewed liquid to flow though the oversized filter basket 42 while retaining the ground coffee. In various embodiments, the microscreen mesh can be made from various materials, for example, stainless steel, gold plated stainless steel, titanium or even paper.

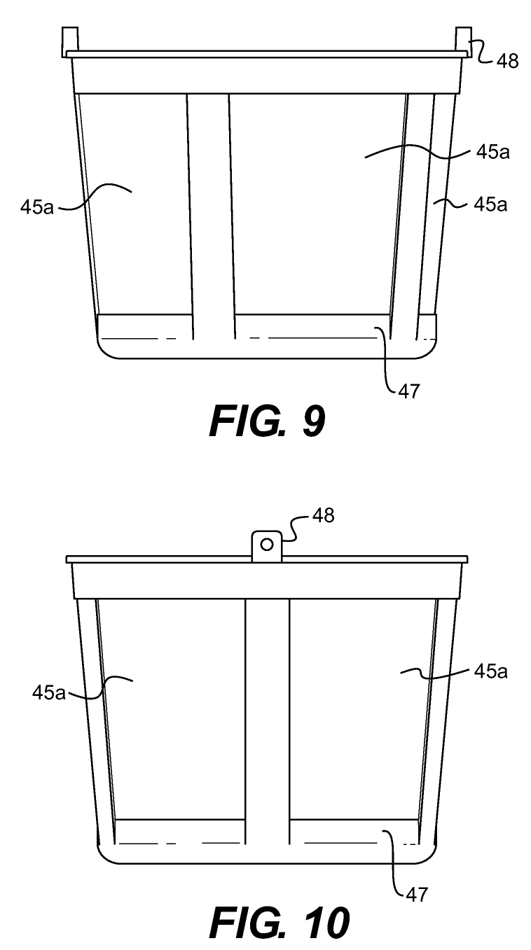

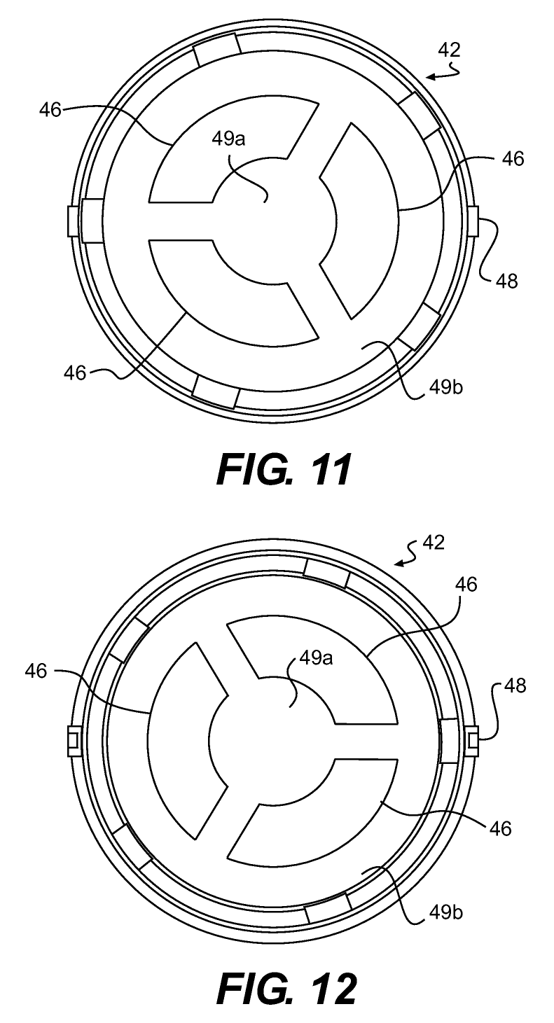

Referring to FIGS. 9 and 10, the detail of the side filter outlets 45a of the oversized filter basket 42 are shown. FIGS. 11 and 12 are a bottom view of the oversized filter basket 42, particularly illustrating the bottom filter outlets 46.

Referring to FIGS. 1 and 13, the drenching shower head 40 allows an even distribution of heated liquid onto the brewing grounds located inside the oversized filter basket 42, thus ensuring maximum flavor extraction from the grounds. In a manner that is well known, liquid from the reservoir enters a heating chamber inside the beverage maker 10 by an element and partially boils the water, producing steam bubbles, which forces the remaining liquid through a riser tube, into the drenching shower head 40, and then down onto the grounds in the oversized filter basket 42 through water ports 41 and water port 41a. The water passes through the grounds and drips down into the liquid carafe 20.

The drenching shower head 40 may be configured with sixteen water ports 41 located near the outer circumference of the drenching shower head 40 with an additional central water port 41a located in the center of the drenching shower head 40. The placement of the water ports provide a thorough drenching of the grounds inside the oversized filter basket 42, and thus produce a higher quality of brew.

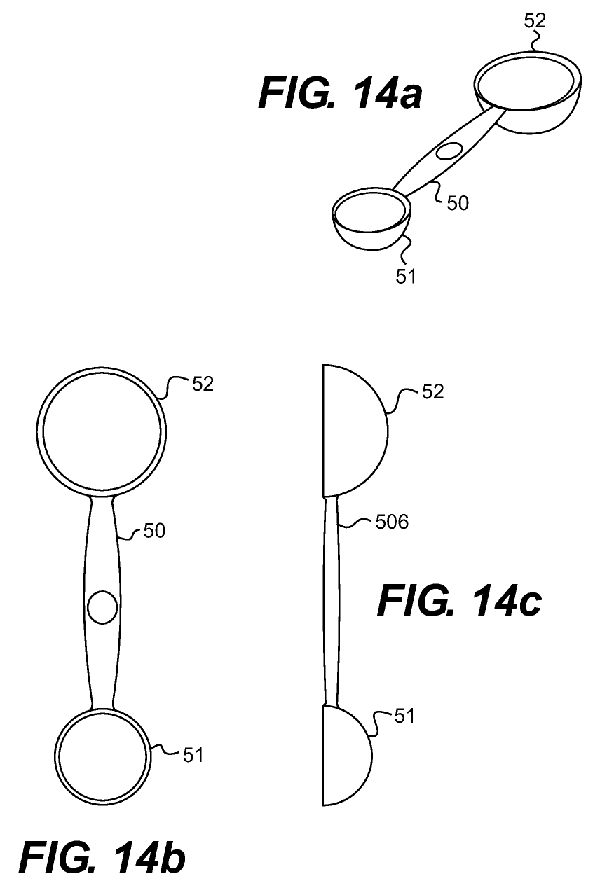

Referring to FIG. 14a, a two sided coffee scoop 50 is shown, a small scoop 51 and a large scoop 52. Depending on the beverage to be brewed, the large or small scoop is chosen to scoop grounds into the oversized filter basket 42. For example, to brew five regular cups of coffee in the beverage maker 10, five scoops of coffee utilizing the small scoop 51 are placed into the oversized filter basket 42. Conversely, to brew five cups of gourmet coffee in the beverage maker 10, five scoops of coffee utilizing the large scoop 52 are placed into the oversized filter basket 42. FIG. 14b is a top plan view of the two-sided scoop of FIG. 14a. FIG. 14c is a side plan view of the two sided scoop of FIG. 14a.

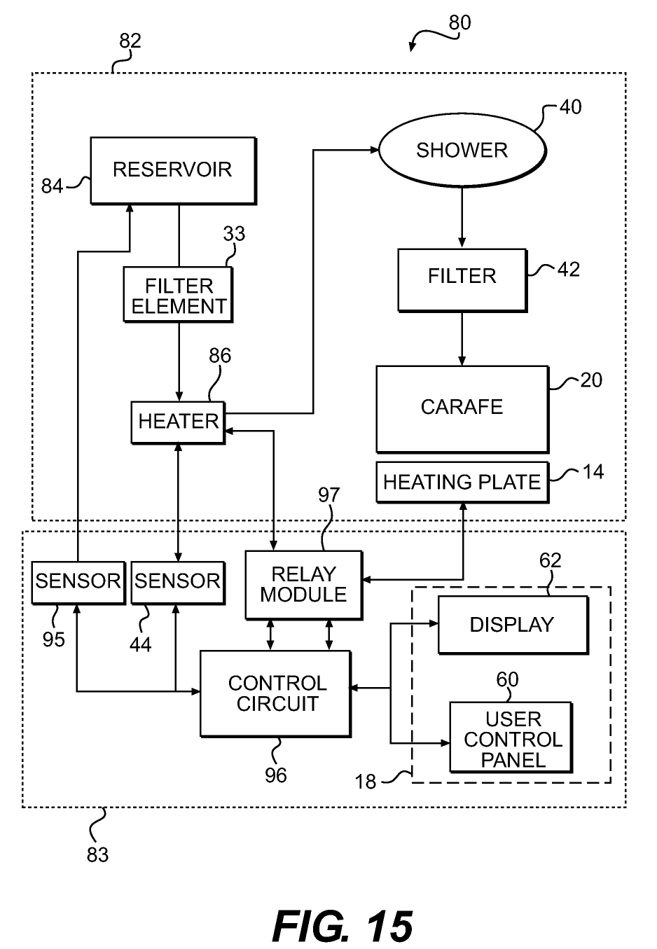

As shown in FIG. 15, the beverage maker 10 has a brew system 82 and a control system 83. The brew system 82 has a container or reservoir 84 for receiving water or another liquid to be brewed. Reservoir 84 may be in fluid communication with a heater 86 through the filter element 33. The reservoir 84 may be filled according to any suitable method including, for example, with a volume of water corresponding to the desired amount of beverage to be brewed. When the reservoir 84 is filled, gravity may cause water from the reservoir 84 to flow through filter element 33 and through the heater 86. A drenching shower head 40 may be in fluid communication with the heater 86, but may be located above the heater 86 such that gravity prevents the water from reaching the drenching shower head 40.

When a brewing process is initiated, the control unit 96 sends a control signal to the relay module 97, which in turn enables power to the heater 86 and may heat up, causing water present at the heater 86 to boil. The force of the resulting steam may force water up to the drenching shower head 40. The drenching shower head 40 may direct hot water and steam towards an oversized filter basket 42, which may include coffee grounds, tea, or any other substance for brewing with the water. Here, the water is transformed into the desired beverage. The beverage leaves the oversized filter basket 42 and is directed to the carafe 20, where it is pooled until it is ready for drinking. A heating plate 14 may be provided and it may also be controlled by the control unit 96. The control unit 96 may send a control signal to relay module 97, which in turn switches the power to the heating plate 14 to maintain the carafe 20, and accordingly the beverage, at a desired temperature.

The relay module 97 may have solid state relays or any type of electrical switch that opens and closes under the control of another electrical circuit. A solid state relay has no moving parts to wear out. For example, in an embodiment, the control circuit 96 may send control signals to the relay module 97 to control the heater 86 and the heating plate 14.

The control system 83 may control various parts of the brewing process, and may provide additional features. For example, the control system 83 may detect the end of the brewing process. A control circuit 96 of the control system 83 may detect the end of the brewing process, for example, in conjunction with one or more sensors 94, 95. The control circuit 96 may be any suitable analog or digital circuit and may include, for example, a microcontroller, a microprocessor, any other suitable processing device for executing instructions stored on a computer-readable medium, or a field programmable gate array (FPGA) or programmable system-on-chip (PSoC). The control circuit 96 may be solid state and/or be made from solid state components. Sensors 94, 95 may be any suitable sensor type (e.g., based on the method used to detect the end of the brewing process).

Various methods may be used to determine the end of the brew process. For example, the control circuit 96 may determine the end of the brew process by monitoring a temperature of the heater 86, for example, via a heat sensor 94. During the brew process, when water is present in the heater 86, its temperature may approximate the temperature at which the water boils (e.g., 100° C. or 212° F. at sea level). When all of the water from the reservoir 84 is exhausted, then the heater 86 may also run dry, causing its temperature to exceed the boiling point. This may indicate the end of the brew process. The control circuit 96 of the system 83 may monitor a temperature of the heater 86 via a heat sensor 94 in communication with the heater 86. When the temperature of the heater 86 increases above the boiling point of water, the control circuit 96 may determine that a brew cycle has ended. Similar results may be obtained by measuring the temperature at other points of the brew system 82 including, for example, fluid lines leading to and/or from the heater. The temperature sensor 94 may be any suitable sensor capable of measuring temperature including, for example, a solid state sensor and/or a thermistor.

The control circuit 96 may determine the end of a brew cycle in other ways. For example, a sensor 95 may be positioned to sense the level of liquid in the reservoir 84. When the level of the liquid in the reservoir 84 drops below a predetermined level, it may indicate that all or a significant portion of the liquid from the reservoir has been brewed and, thus, the brew cycle is complete. In another embodiment, the control circuit 96 may be configured to measure a liquid level in the reservoir 84 at the start of a brew cycle. Based on this information, the control circuit 96 may estimate the end of the brew cycle, for example, using a timer. Because the duration of a brew cycle depends on the amount of liquid to be brewed, knowing the amount of liquid in the reservoir 84 at the beginning of the brew cycle may allow the control circuit 96 to estimate the duration of the brew cycle and determine the end of the brew cycle using a timer.

When the end of the brew cycle is detected, the control system 83 may take various actions including, for example, de-activating the heater 86. According to various embodiments, the control system 83 may also implement a time since brew timer. For example, when the control circuit 96 detects the end of the brew cycle, it may initiate a time since brew (TSB) timer. The end of the brew process may be detected via any suitable method including, for example, by monitoring the temperature of the heater 86 as described above. The TSB timer may be a software-based timer implemented by the control circuit 96 or a component thereof, or may utilize a discrete hardware component. The TSB timer may begin at zero and may count the time that passes after it is activated (e.g., at the end of a brew cycle). The current value of the TSB timer may be expressed in any suitable format including, for example, minutes, or hours plus minutes.

The state of the TSB timer may be provided to the user via the display 62. This may give the user an indication of how much time has passed since the end of the brew cycle and, accordingly, the age of the beverage in the carafe 20. The state of the TSB timer may be indicated in any suitable way. For example, a light may be illuminated to indicate when a predetermined time has past since brewing. Also, in addition to or instead of the illumination of a light, an audible sound such as a beep may be generated when the predetermined time has elapsed. In some embodiments, the display 62 may be configured to display the current value of the TSB timer. For example, a control panel 60 may have a button or other input device that when actuated by the user, causes the control circuit 96 to display the current value of the timer at the display 62. According to various embodiments, the control circuit 96 may be further configured to deactivate the heating plate 14 when a predetermined interval (e.g., 2 hours) has passed since the end of the brew cycle. The predetermined interval may be measured by the TSB timer.

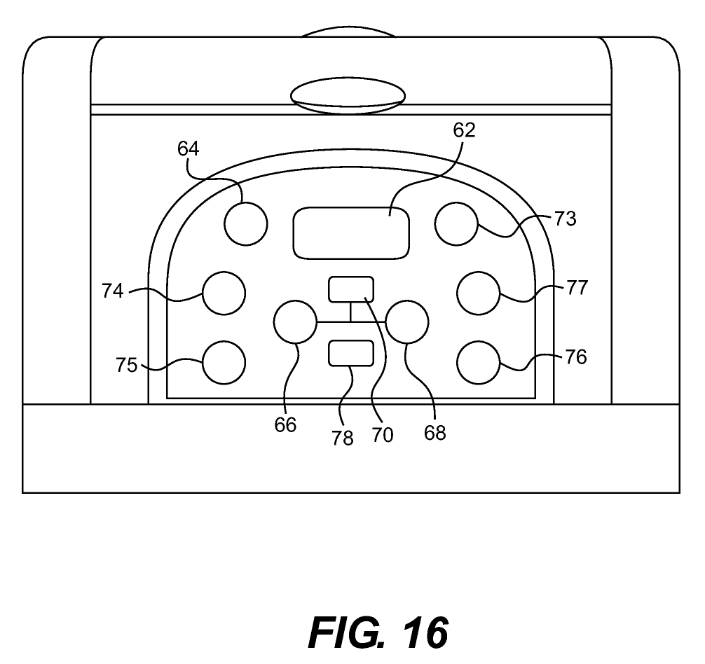

FIG. 16 illustrates a control panel 18 that, in various embodiments, may serve as both a display 62 and a user control panel 60. The display 62, may be an LCD, LED or other suitable display. Additionally, the display 62 may be used to display the current value of the TSB timer or the current time.

The user control panel 60 may have an on/off button 64 to turn the beverage maker 10 on or off and may initiate the brewing process. The user may select a programmed or delayed brew by selecting program button 70 and entering a desired start time and/or delay time utilizing an hour button 66 and a minute button 68. An auto button 73 may be activated to initiate a programmed brew. The TSB 76 may be depressed by the user to cause the control circuit 96 to display the current state of the TSB timer on the display 62. The beverage maker 10 may have a clean switch 77 accessible from the control panel 18 that may be actuated by a user to initiate the automatic cleaning process. The clean switch 77 may be in the form of a push button switch, for example.

To brew regular coffee, the regular brew coffee button 75 is selected to place the beverage maker 10 in a regular brew mode. As an alternative to regular brew mode, a gourmet coffee brew button 74 may be selected to allow the user to place the beverage maker 10 into a gourmet mode. The regular brew coffee button 75 or the gourmet brew button 74 can be depressed by the user either before pressing the on/off button 64 or within a predetermined time. When in alternate brew mode, the control circuit 96 of the control system 83 may alternately turn the heater 86 on and off at a predetermined interval (e.g., every twenty-five seconds). This allows the liquid to linger longer at the oversized filter basket 42 and remain in contact with the grounds longer which may, in turn, leads to the gourmet brew. In alternative embodiments, the beverage maker 10 may also be placed into alternate brew modes, which will vary the heat and timing of the brew process.

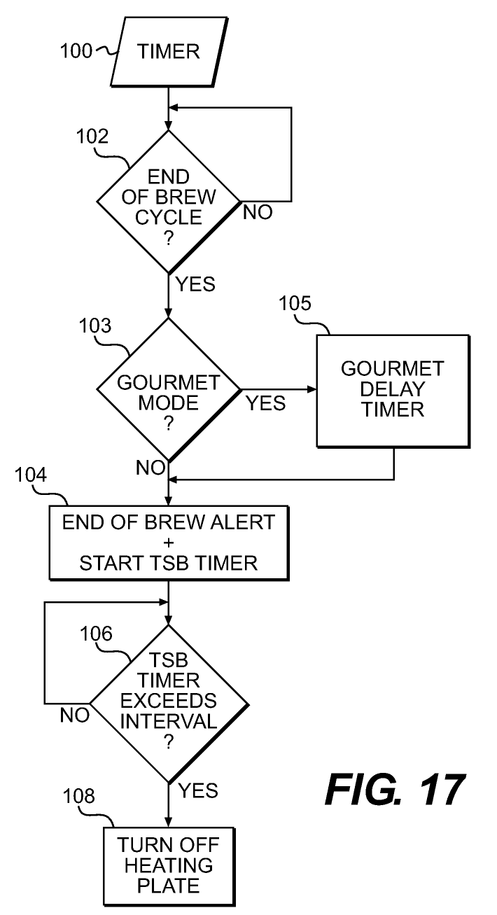

An example of a brewing process will be detailed with reference to FIGS. 15 and 17. A brew timer 100 initiates and waits for the end of brew cycle 102 to complete via an indicator to the control circuit 96. The control circuit 96 determines whether there has been a change in the reading from sensor 94, which indicates the end of brew cycle. When the signal is received, the control circuit 96 may then determine if the beverage maker is in gourmet mode 103. If the beverage maker is in the gourmet mode 103, a gourmet delay timer 105 is started, which allows the remaining brew to filter out of the oversized filter basket. As discussed above, in gourmet mode there may be additional grounds in the oversized filter basket and the gourmet delay timer 105 is provided to make sure that all the ground's flavors and essence are allowed to flow out of the grounds. When the gourmet delay timer 105 is complete or when the end of brew cycle 102 indicates an end of a regular brew, an end of brew alert may be indicated, as well as the initiation of the TSB timer 104. The control circuit 96 may determine whether the current value of the TSB timer exceeds a predetermined interval (e.g., two hours) at decision block TSB exceeds interval 106.

In certain embodiments, the TSB timer may be programmatically set by the user to meet the user's method of use. For example, if a user brews coffee at 6:00 a.m. and departs for work at 6:30 a.m., the TSB timer can be set for 30 minutes. At 6:30 a.m. the beverage maker 10 would shut itself off, thus saving energy. Additionally, when a predetermined interval is reached, it may indicate that the beverage is beyond a desirable drinking age. Accordingly, if the predetermined interval is reached, the control circuit 96 may disable the heating plate 14 at 108, allowing any beverage present in the carafe 20 to cool. According to various embodiments, the control circuit 96 may turn off the entire beverage maker 10. In certain embodiments, the beverage maker 10 may have a TSB off indicator 78 located on the control panel 60 indicating that the TSB timer has cycled and the beverage maker 10 has shut itself off. The indicator may be an LED or other suitable light emitting device.

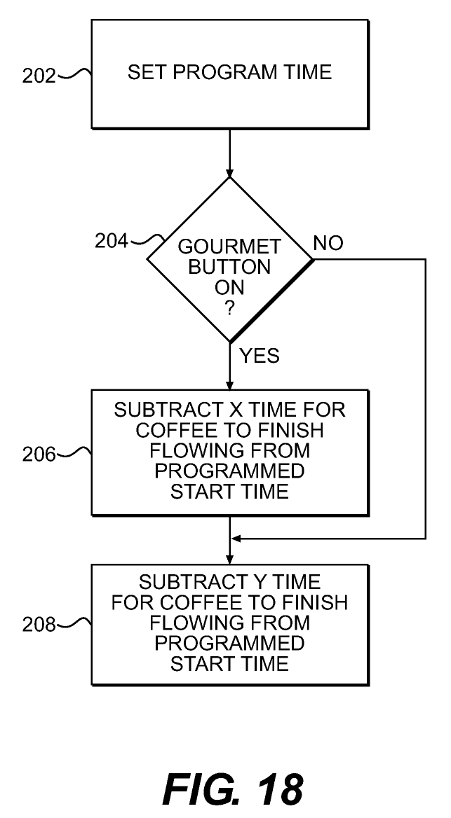

FIG. 18 is a process flow illustrating an end brewing timer. A user would input a time in which they would want to have the brewing process done, at step 202. For example, the user wishes to have non-gourmet coffee at 6:00 a.m., the user would set the timer to 6:00 a.m. and not enable the gourmet mode 204. The end brewing timer would start the brewing process at a time “y” earlier than 6:00 a.m. 208, thus, ensuring the brewing process would be complete at 6:00 a.m. The time “y” would be the time for a regular brew to complete in the beverage maker 10 and this time would be determined by the brewing characteristics of the beverage maker 10 and stored in a look up table (LUT).

In an alternative example, if the user wishes to have gourmet coffee at 6:00 a.m., the user would set the timer to 6:00 a.m., and enable the gourmet mode 204. Thus, the start of the brewing process would start at a “x”+“y” time before 6:00 a.m. 208. The additional “x” time is the additional time required for the liquid to flow through the additional grounds located in the oversized filter basket 42 when producing a gourmet brew 206. The times for “x” and “y” would be determined by the brewing characteristics of the beverage maker 10 and stored in a look up table (LUT).

In additional embodiments, referring to FIG. 15, the control system 83 may be configured to provide a cleaning/maintenance reminder to a user, and to enable user initiation of an automatic cleaning process implemented by the control system 83. In certain embodiments, the beverage maker 10 may comprise a clean indicator (e.g., an LED or other suitable light emitting device) located on the control panel 60 for providing the cleaning/maintenance reminder. The control system 83 may monitor usage of the beverage maker 10 to control the status of the clean indicator. In certain embodiments and as described below in connection with FIG. 15, for example, the control circuit 96 may monitor usage by tracking the number of brew cycles performed by the beverage maker 10. According to such embodiments, if the number of tracked brew cycles equals a predefined number, the control circuit 96 may activate the clean indicator in order to provide the cleaning/maintenance reminder to the user. In embodiments in which the clean indicator is a light-emitting device, for example, the control circuit 96 may cause the clean indicator to transition from a non-illuminated state to an illuminated state. In this way, a user is reminded to attend to the cleaning and maintenance requirements of the beverage maker 10. Such requirements may include, for example, the need to remove mineral buildup, lime scale deposits, and/or other contaminants that have accumulated within the beverage maker over time, and the need to replace the filter 34.

Referring to FIG. 15, in embodiments in which the clean indicator is implemented using a light-emitting device, the clean indicator may be integrally formed with the clean switch 77, as described below in connection with FIGS. 5-8 and 19, the automatic cleaning process may include performing a number of alternating brew cycles to pass a suitable cleaning agent (e.g., a descaling product or a vinegar solution) through the beverage maker. Accordingly, prior to initiating the automatic cleaning process, the filter 34 may be removed from the beverage maker by first removing the filter dipstick 32 from the beverage maker, and, if necessary, removing the filter element 33 from a filter cage 35 of the filter dipstick for disposal.

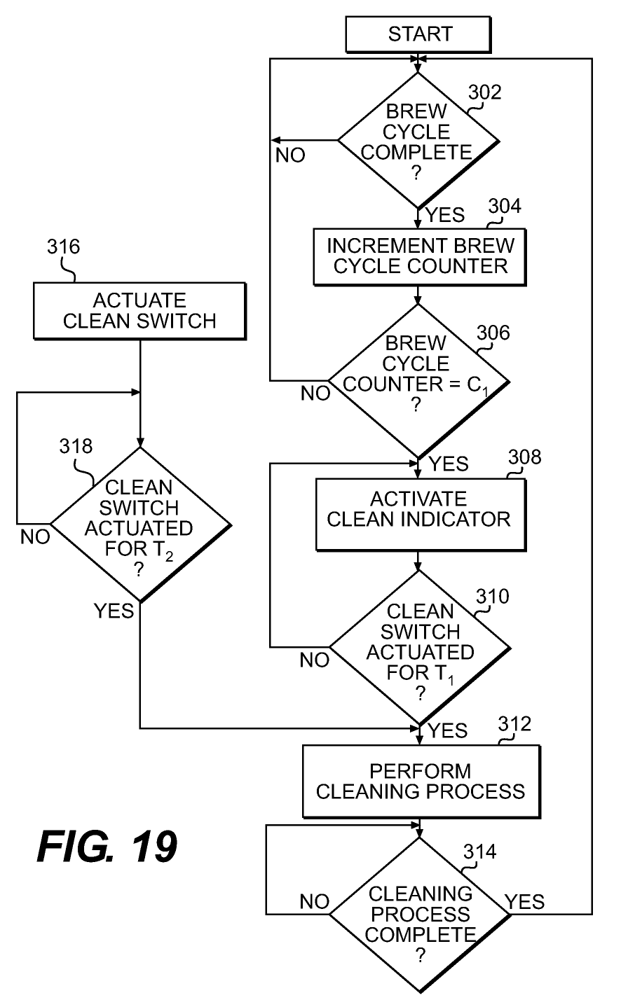

FIG. 19 is a process flow illustrating a method of providing a cleaning/maintenance reminder to a user and enabling user initiation of an automatic cleaning process. At 302, the control circuit 96 of FIG. 15 may determine whether a brew cycle has ended. In certain embodiments, and as discussed above in connection with FIG. 15, the control circuit 96 may monitor the temperature of the heater 86 via the sensor 94 to make this determination. If the control circuit 96 determines a brew cycle has ended, a brew cycle counter contained within the control circuit 96 is incremented by one at count 304. Otherwise, the process returns to 302.

The value of the brew cycle counter is monitored at 306. If the value of the brew cycle counter is less than a predefined brew cycle count C₁, the process returns to 302, and the value of the brew cycle counter will continue to increase as additional brew cycles are performed. If the value of the brew cycle counter is equal to the predefined brew cycle count C₁, the control circuit 96 may activate the clean indicator to provide a cleaning/maintenance reminder to the user. According to various embodiments, the predefined brew cycle count C₁ is equal to 60, although it will be appreciated that the C₁ may generally be any suitable value. In certain embodiments, for example, depending on whether beverage maker 10 is intended for use with hard water and/or beverage products associated with relatively high levels of residue, the value of C₁ may be decreased or increased such that clean indicator is activated more or less frequently, respectively, for a given amount of beverage maker use. In certain embodiments, the value of C₁ may be based on the type of filter 34 used in the beverage maker 10. For example, if the filter 34 is designed to provide effective filtration for 60 brew cycles, the value of C₁ may be selected to be 60.

At 310, the status of the clean switch is monitored. If the clean switch is actuated for a time less than T₁, or not actuated at all, the process returns to 308, and the clean indicator remains in the activated state. Generally, time T₁ may be selected to prevent inadvertent initiation of the automatic cleaning process (e.g., by accidentally bumping the clean switch). In one embodiment, for example, T₁ is 3 seconds. It will be appreciated, however, that T₁ may be greater or less than 3 seconds.

If the clean switch is actuated for a time in excess of T₁, the process proceeds to 312, and the automatic cleaning process is performed. During at least a portion of the automatic cleaning process, the control circuit 96 may cause the clean indicator to flash (in embodiments in which the clean indicator is a light-emitting device), thus indicating to a user that the automatic cleaning process is in progress. Additionally, in certain embodiments, the control circuit 96 may operate to disable other features of the control panel 60 (with the exception of a power switch for turning the beverage maker 10 off) from being used during the automatic cleaning process. The status of the cleaning process is monitored at 314. Upon completion of the cleaning process, the process returns to 302.

In certain circumstances, it may be necessary or otherwise desirable to initiate the automatic cleaning process before the brew cycle counter is equal to the predefined brew cycle count C₁. Accordingly, in certain embodiments and as shown at 316 of FIG. 19, the clean switch may be actuated to initiate an automatic cleaning process when the clean indicator is not activated. If the clean switch is actuated for a time in excess of T₂, as determined at 318, the process proceeds to 312, and the automatic cleaning process is performed. In one embodiment, the value of T₂ may be equal to that of T₁. In another embodiment, the value of T₂ may be different than that of T₁.

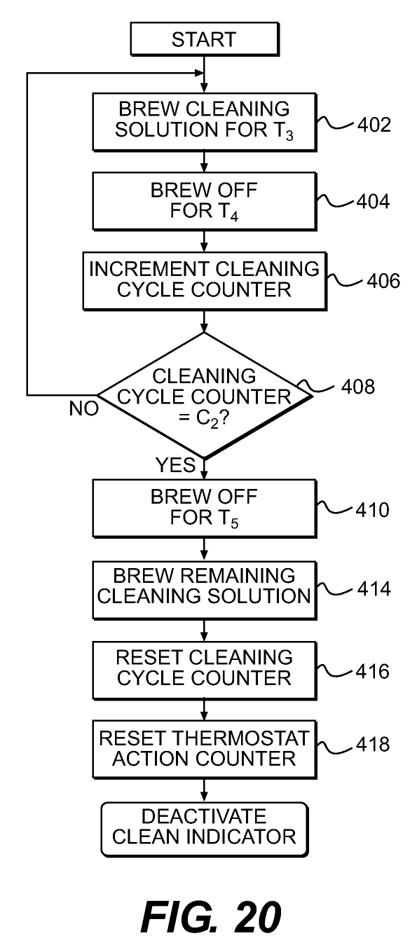

FIG. 20 is a process flow illustrating a method of performing the cleaning process of 312 (FIG. 19). In certain embodiments and as discussed above, prior to initiation of the cleaning process, the filter 34 has been removed from the filter dipstick 32, and a suitable amount of cleaning agent has been poured into the reservoir 84.

At 402, the control circuit 96 may initiate a brewing cycle such that cleaning agent present at the heater 86 is boiled to force cleaning agent up to the drenching shower head 40 and into the carafe 20. The brewing process may be performed for a time T₃, after which the brewing process is turned off by the control circuit 96 for a time T₄ at 404. Next, at 406, a cleaning cycle counter contained within the control circuit 96 is incremented by one count. The value of the cleaning cycle counter is monitored at 408. If the value of the cleaning cycle counter is less than a predefined cleaning cycle count C₂, the process returns to 402, and the value of the cleaning cycle counter will continue to increase as additional brewing cycles are performed at 402 and 404. When the value of the cleaning cycle counter is equal to the predefined cleaning cycle count C₂, the process proceeds to 410, where the brewing process remains off for a time T₃. During this time, cleaning agent introduced into the brew system 82 may interact with and loosen mineral deposits and accumulated contaminants. Values of T₃, T₄, C₂, and T₅ and may be selected such that cleaning agent is introduced into the brew system 82 in a sufficient amount and for a sufficient time to adequately clean the brew system components, and such that the cleaning process is not unnecessarily long. In certain embodiments, for example, T₃ is 7 seconds, T₄ is 21 seconds, C₂ equals 60, and T₅ is 30 minutes. In certain embodiments, the automatic cleaning process may be completed in an hour or less. From 410, the process proceeds to 412 at which the remainder of the cleaning agent is continuously brewed until the reservoir 84 is emptied. The cleaning cycle counter and the brew cycle counter values are reset to zero at 414 and 416, respectively, and the cleaning process is completed at 418 by deactivating the clean indicator. Subsequent to completion of the cleaning process at 418, an unused filter 33 may be placed into the filter cage 35 of the filter dipstick 32, and the filter dipstick 32 may then be reinstalled into the beverage maker 10.

The processes and devices in the above description and drawings illustrate examples of only some of the methods and devices that could be used and produced to achieve the objects, features, and advantages of embodiments described herein. Thus, they are not to be seen as limited by the foregoing description of the embodiments, but only limited by the appended claims. Any claim or feature may be combined with any other claim or feature within the scope of the invention.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described and accordingly, all suitable modifications and equivalents falling within the scope of the invention.

What is claimed:

1. A beverage maker, comprising:
a filter basket;
a brew system comprising
a reservoir to receive a liquid;
a heater to heat the liquid;
an expendable filter structured to filter impurities from the liquid for at least a predetermined number of brew cycles;
a container for receiving a beverage brewed from the filtered liquid;
an indicator to indicate at least one of a cleaning and a maintenance need of the beverage maker; and
a control circuit comprising a processor, wherein the control circuit is configured to:
acquire an input from a gourmet brew switch in communication with the control circuit indicative of a gourmet brew mode;
receive a signal from at least one sensor indicative of an end of a brew cycle; and
indicate to a first indicator the end of brew cycle.

2. The beverage maker of claim 1, wherein the control circuit increments a brew cycle counter by one count at the end of each brew cycle and activates a second indicator when a value of the brew cycle counter is equal to the predetermined number of brew cycles.

3. The beverage maker of claim 1, wherein the beverage maker comprises a gourmet scoop with a large and a small scoop affixed at each end of said gourmet scoop.

4. The beverage maker of claim 1, wherein the filter basket comprises side filter outlets and bottom filter outlets to assure swift and efficient flow.

5. The beverage maker of claim 1, wherein the container comprises a removable carafe.

6. The beverage maker of claim 1, wherein the at least one sensor comprises a solid state sensor.

7. The beverage maker of claim 5, wherein the at least one sensor comprises a thermistor.

8. The beverage maker of claim 1, wherein the at least one sensor is positioned to sense the temperature at the heater.

9. The beverage maker of claim 1, wherein the control circuit is configured to:
determined if in the beverage maker is in the gourmet mode, activate the brew system for a first predetermined amount of time to allow liquid in a filter to flow out of the filter, and
deactivate the brew system after a predetermined amount of time.

10. The beverage maker of claim 1, comprising a clean switch in communication with the control circuit, the clean switch actuatable to initiate an automatic cleaning process.

11. The beverage maker of claim 9, wherein the clean indicator is integrally formed with the clean switch.

12. The beverage maker of claim 1, wherein the control circuit is configured to:
for a predetermined number of cycles, activate the brew system for a first predetermined amount of time to introduce cleaning agent contained in the reservoir into the beverage maker, and
deactivate the brew system for a second predetermined amount of time;
deactivate the brew system for a third predetermined amount of time; and
activate the brew system to pass a remaining amount of the cleaning agent contained in the reservoir through the beverage maker.

13. A method of operating a beverage maker, the beverage maker comprising at least one brewing mode, the method comprising:
acquiring an input from a gourmet brew switch, wherein said signal is indicative the beverage maker is in gourmet mode;
receiving a signal from at least one sensor, wherein the signal is indicative of an end of a brew cycle of the beverage maker;
waiting a predetermined gourmet time to ensure that the liquid in the filter basket is emptied; and
indicating an end of brew alert.

14. The method of claim 13, further comprising:
incrementing a brew cycle counter by one count at the end of each brew cycle;
activating a clean indicator of the beverage maker when the brew cycle counter is equal to a predetermined brew cycle count; and
removing the filter from the beverage maker responsive to activation of the clean indicator.

15. The method of claim 13, further comprising:
starting a time since brew (TSB) timer after indicating said end of brew alert;
checking the TSB timer against a preset TSB time; and
deactivating a heating element.

16. The method of claim 15, wherein a user sets the TSB timer to a desired time.

17. The method of claim 13, further comprising:
selecting a beverage mode for said beverage maker;
programming a brew complete time via panel switches;
subtracting an early time from said brew complete time, wherein said early time is based upon said beverage mode; and
enabling a delay brew timer.

18. The method of claim 13, comprising:
actuating a clean switch of the beverage maker;
for a predetermined number of cycles, activating a brew system of the beverage maker for a first predetermined amount of time to introduce cleaning agent into the beverage maker, and deactivating the brew system for a second predetermined amount of time in response to the actuating the clean switch;
maintaining the brew system in a deactivated state for a third predetermined amount of time; and
activating the brew system to pass a remaining amount of the cleaning agent through the beverage maker.

19. The method of claim 13, comprising installing an unused filter into the beverage maker subsequent to passage of the remaining amount of the cleaning agent through the beverage maker.

20. A control circuit for controlling a beverage maker, the control circuit comprising:
a processor in communication with a computer-readable medium, wherein the computer-readable medium comprises instructions stored thereon, which, when executed by the processor, cause the processor to:
acquire an input from a gourmet brew switch in communication with the control circuit indicative of a gourmet brew mode;
receive a signal from at least one sensor indicative of an end of a brew cycle; and indicate to a first indicator the end of brew cycle.

21. The method of claim 20, wherein the instructions, when executed by the processor, cause the processor to:
increment a brew cycle counter by one count at the end of each brew cycle; and
activate a clean indicator of the beverage maker when a value of the brew cycle counter is equal to a predetermined number of brew cycles.

22. The method of claim 20, wherein the instructions, when executed by the processor, cause the processor to:
responsive to actuation of a clean switch of the beverage maker:
for a predetermined number of cycles, activating a brew system of the beverage maker for a first predetermined amount of time to introduce cleaning agent into the beverage maker, and deactivating the brew system for a second predetermined amount of time;
maintaining the brew system in a deactivated state for a third predetermined amount of time; and
activating the brew system to pass a remaining amount of the cleaning agent through the beverage maker.
